(19) United States
(12) Patent Application Publication
(10) Pub. No.: US 2024/0219265 A1
(43) Pub. Date: Jul. 4, 2024

(54) Self-Propelled Platform for Simulating Traffic Conditions

(71) Applicant: 4activeSystems GmbH, Traboch (AT)

(72) Inventors: Martin Fritz, Kobenz (AT); Reinhard Hafellner, Spielberg (AT)

(21) Appl. No.: 18/558,016

(22) PCT Filed: Dec. 23, 2021
(86) PCT No.: PCT/EP2021/087589

§ 371 Date: Oct. 30, 2023

(30) Foreign Application Priority Data
Apr. 30, 2021 (AT) A 60126/2021

(51) Int. Cl. G01M 17/007

(52) U.S. Cl. CPC G01M 17/0074

(57) ABSTRACT

Embodiments of the present invention relate to a platform for a dummy for simulating traffic situations. The platform comprises a base body which comprises a bottom surface and a surface which is formed opposing to the bottom surface, and at least one roller element which is arranged at the bottom surface, wherein the roller element is configured such that the base body is displaceable along a ground by the roller element, wherein the base body comprises an attachment region and an installation region. On the attachment surface of the attachment region, an attachment device for attaching the dummy is formed, wherein in the installation region, functional elements are installable. The base body is configured so thin, that a collision vehicle can drive over the base body without a damage.

### CROSS-REFERENCE TO RELATED APPLICATIONS

This application is the U.S. national phase of International Application No. PCT/EP2021/087589 filed Dec. 23, 2021, which designated the U.S. and claims priority to Austrian Patent Application No. A 60126/2021, filed Apr. 30, 2021, the entire contents of each of which are hereby incorporated herein by reference.

### TECHNICAL FIELD

Embodiments of the present disclosure relate to a platform for a dummy for simulating traffic situations.

### BACKGROUND OF THE DISCLOSURE

Motor vehicles are increasingly equipped with driver assistance systems, to actively support the driver of the motor vehicle in certain traffic situations, and to reduce the risk of accidents. For example, modern driver assistance systems may influence the braking function or the steering of the motor vehicle.

Furthermore, autonomously driving motor vehicles are used in modern traffic areas, wherein the motor vehicle fully automatically steers through the traffic of a certain traffic area, without the driver actively participating in the driving behavior of the motor vehicle.

For testing motor vehicles with driver assistance systems or for testing autonomously driving motor vehicles, complex traffic scenarios with a plurality of traffic participants have to be reproduced.

Driving platforms are known on which a desired dummy, such as a vehicle or a human body, can be attached. However, in case of malfunctions of the driver assistance systems, collisions may be caused unintentionally or intentionally during a test, such that the vehicle to be tested drives over the platform. When driving over the platform with the vehicle to be tested, it should remain undamaged, if possible, and should also be available for further tests.

### SUMMARY

There may be a need to provide a driving platform on which a dummy is attachable, wherein the platform is configured such that a collision vehicle can drive over the platform without a damage.

This need is met by the subject matter of the independent claim.

According to a first aspect of the present disclosure, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element, wherein the base body comprises an attachment region and an installation region. On the attachment surface of the attachment region, an attachment device for attaching the dummy is formed, wherein functional elements are installable in the installation region. The base body is configured so thin, that a collision vehicle can drive over the base body without a damage.

### Overview of Embodiments

According to a further aspect, a method for operating the above-described platform and a method for manufacturing the above-described platform are described.

For example, the vehicle to be tested (collision vehicle) may constitute an autonomously moving object, for example a vehicle, such as a car, a truck, a bus, or a bicycle.

The dummy which is attached on the platform is a human-like dummy, for example, which is attached on the platform in a standing, lying, or sitting manner. Furthermore, the dummy may constitute a vehicle replica or a bicycle replica.

The platform comprises the base body which has a plate-like shape. This means that its extension within a bottom plane is significantly larger than its thickness in a vertical direction, for example. The base body comprises a bottom surface and an opposing surface. The base body is placed on a ground with its bottom surface. In this case, the bottom surface is parallel to the ground or to the ground plane. In the bottom surface, the at least one roller element is rotatably arranged, which at least partially protrudes from the base body and thus provides a distance between the base body and the ground. On the surface, an attachment device is formed. The attachment device is configured for fixing the dummy. Furthermore, the attachment device may be controllable, to selectively release the test object, for example just before a collision situation, such that the attachment between the base body and the test object is released.

In the following, the ground plane (horizontal plane) is used as a reference system, wherein, when the platform is placed on the ground, the bottom surface is in parallel to the ground plane. Thus, the ground plane is defined by an x-axis (for example in a driving direction of the platform) and a Y-axis. Therefore, the x-axis and the Y-axis lie in the ground plane. The z-axis is arranged perpendicular to the ground plane and thus in parallel to a normal of the ground plane (vertical).

In particular, the platform comprises an installation region in which all functional elements, such as the drive units or communication units of the platform, are arranged. In the attachment region, the dummy is attached on the attachment surface. Along the ground plane, the platform is divided in the attachment region and the installation region.

For example, the attachment device may consist of a hook system in which the dummy may be suspended. Furthermore, the attachment device may comprise a magnet, in particular a controllable electromagnet, to attach the dummy on the surface by a magnetic holding force.

The at least one roller element is arranged at the bottom surface. In a preferred embodiment, three or four roller elements may be arranged spaced apart from each other at the base body at the bottom surface. Thus, a high rolling stability and a good controllability of the platform are given. The roller element may consist of rubber rollers, hard plastic rollers, or plastic rollers, for example.

The platform is displaceable along the ground by the at least one roller element. A tensile mechanism, such as a tensile rope or a tensile rod, may be attached at the base body, to draw the platform over the ground. Furthermore, the base body may be attached on a guiding rail, wherein the base body with the roller element is displaceable along the guiding rail. Furthermore, the platform may be configured freely displaceable, by driving the roller element itself, as described in more detail below.

According to the disclosure, the platform is configured so thin, that a collision vehicle can drive over the base body without a damage. In this respect, preferred embodiments are described in the following, which all together contribute to a thin and robust configuration of the platform according to the disclosure.

According to a first exemplary embodiment, the base body is step-shaped, wherein in particular an attachment thickness between the bottom surface and the surface in the attachment region is, in particular 30 mm, 25 mm, 20 mm, 15 mm, 10 mm, or 5 mm, smaller than an installation thickness between the bottom surface and the surface in the installation region. The minimum difference between the installation thickness and the attachment thickness is at least 1 mm to 2 mm in case of the step-shaped configuration.

According to a further exemplary embodiment, the attachment thickness is less than 40 mm, in particular less than 35 mm, less than 30 mm, less than 25 mm, less than 20 mm, less than 15 mm, less than 10 mm. The installation thickness may be less than 60 mm, less than 55 mm, in particular less than 50 mm, less than 45 mm, less than 40 mm, less than 35 mm, less than 30 mm, less than 25 mm, less than 20 mm, less than 15 mm, less than 10 mm. The maximum thickness of the platform between a ground bearing (German: Bodenauflage) of the roller element (i.e. the region of the roller element which is farthest away from the surface of the platform, when the platform rests on the ground in an unloaded manner) on the ground and the surface, in particular the installation region, is less than 60 mm, less than 55 mm, in particular less than 50 mm, 45 mm, 40 mm, or 35 mm. However, in case of a homogenous, stepless platform, the maximum thickness may also be present in the attachment region. In other words, in a stepless configuration of the platform, the attachment thickness may be the same as the installation thickness.

Therefore, the platform comprises two differently thick regions. In the thicker installation region, the functional elements are accommodated which typically require a larger thickness. In the attachment region on which the dummy is attached, for example exclusively driveless roller elements are located, such that no further thicker functional elements have to be installed. The attachment region may therefore be configured thinner than the installation region. Thus, exclusively the required thickness for the functional elements is used, and in other regions, in particular in the attachment region, the maximum possible thinnest design is possible. It is in particular advantageous that an extremely thin attachment region can be provided, so that the dummies which are attached on it are located extremely close to the ground. This leads to a reduction of false measurements of sensors of the driver assistance systems, since the bottom of a dummy is almost on the same level as the ground, for example, and only the thin installation region of the platform is in between. Thus, a real dummy, such as a pedestrian which walks on the ground, can be realistically simulated.

According to a further exemplary embodiment, the attachment region comprises more than 30%, in particular more than 40%, 50%, or 70%, of the surface of the base body. In particular, the thin attachment region may occupy more than half of the area within the bottom plane of the platform, such that only a small installation region has to comprise a higher thickness for the functional elements.

According to a further exemplary embodiment, between the installation region and the attachment region, a transition region is formed, wherein the surface in the transition region comprises an angle to the surface in the installation region (and/or the attachment region) between 5° and 45°, in particular between 5° and 15°. In particular, the angle is measured between the plane (or its normal) in which the transition region is located, and the ground plane (or its normal). In particular when forming the transition region with an inclined, oblique course, a direct reflection of sensor beams, such as radar waves, may be avoided. In particular, in contrast to a step-shaped transition (angle=90°), wherein the radar waves are reflected directly back, in case of the angle, in particular in case of the above-described smaller angle ranges of the transition region, the radar waves are in particular (vertically) emitted in the direction of the sky and do therefore not cause false measurements.

According to a further aspect of the present disclosure, the base body comprises outer edge regions which surround the attachment region and/or the installation region, wherein the outer edge regions are configured wedge-shaped and wherein at least one wedge-shaped outer edge region comprises an opening angle of approximately less than 25°. The wedge-shaped outer edge regions form a ramp over which the collision vehicle can gently reach on the covering surface or the surface of the platform, and can drive over the entire platform. In particular, the opening angle is measured between the ground plane (or its normal) and the plane (or its normal) in which the surface of the wedge-shaped outer edge regions is arranged. Moreover, by the wedge-shaped outer edge regions, a reflection of sensor radiation is reflected with a vertical component, such that the risk of false measurements is reduced.

According to a further exemplary embodiment, the outer edge regions comprise a radiation absorbing, in particular radar waves absorbing, surface. The surface comprises e.g. IR/RAM-coatings (infrared IR; radar waves absorbing material RAM). Such coatings comprise radar absorbing properties with low emissions in the relevant infrared wavelength ranges. For example, dielectric IR-coatings may be used. Such materials consist of a IR cover layer and a RAM or a quasi-homogenous mixture of RAM and IR-material below the IR cover layer, for example C-RAM paint (U,S,E) HP or C-Ram paint (U,S,E) VHP of the company Cuming Microwave (Technical Bulletin 340-1). Such a coating reaches an absorption of approximately −30 dB in a frequency band of 8-18 GHz, for example.

According to a further exemplary embodiment, the surface comprises a grey coating, in particular RAL 7005 or RAL 7035.

Due to the absorbing character of the radiation absorbing, in particular radar waves absorbing, surface of the outer edge regions, false measurements may therefore be reduced.

According to a further exemplary embodiment, the surface in the region of the roller element comprises a dome-shaped covering element. Thus, despite a narrow installation region, roller elements with a larger roller radius can be used. The installation space which is required for this purpose may be generated by the dome-shaped covering elements. In addition, due to the dome shape, sensor radiation is not directly reflected, but with a vertical component, such that false measurements can be reduced. The dome-shaped covering elements may also be coated with a signal absorbing paint, e.g. with a grey paint (e.g. RAL 7005 or RAL 7035).

According to a further exemplary embodiment, the platform further comprises a drive train (German: Antriebsstrang) which comprises a drive unit, wherein the roller element is coupled with the drive unit for transferring a drive torque. The drive train and the roller element are coupled along an axial direction behind each other, such that the drive train together with the roller element is at least partially arranged in a receiving opening in the bottom surface of the base body, wherein the drive train with the roller element is arranged pivotably into and out of the receiving opening.

The term drive train of the platform denotes all components which generate the power for the drive in the platform and transfer it up to the roller element and/or on the ground. The drive train correspondingly comprises the drive unit, in particular an electric motor, which transfers a corresponding drive torque via a drive shaft on the rotary shaft of the roller element, in order to drive it.

The drive train may comprise a housing and/or a supporting structure, for example, in which all functional mechanical components, such as the drive unit or bearings for the shafts are arranged. According to the disclosure, the drive train is pivotably arranged at the base body, such that in case of a load (in particular a weight force by a collision vehicle which is driving over it) in the vertical direction, the drive train together with the roller element is pivoted in the direction of the platform, to damp the load stress and, if necessary, to securely accommodate the roller element together with the drive train in a receiving region, for example in an installation box, such that no further weight force of the collision vehicle is transferred to the drive train and the roller element. This is in particular possible, when in a pivoted-in state of the drive train and the roller element in a receiving region of the platform and/or of the base body, the entire weight force of the platform and the collision vehicle which is driving over it is introduced via the base body in the ground and no longer via the roller element. Therefore, a thin platform may be provided which is highly robust with respect to heavy collision vehicles (for example high load trucks).

According to a further exemplary embodiment, the drive unit comprises a drive shaft, and the roller element comprises a rotary shaft, wherein the drive unit and the roller element are arranged such that the drive shaft and the rotary shaft are in parallel to the axial direction.

According to a further exemplary embodiment, the drive unit and the roller element are arranged such that the drive shaft and the rotary shaft are coaxial.

According to a further exemplary embodiment, the drive train comprises a gear unit, in particular a planetary gear, which is arranged between the drive shaft and the rotary shaft, such that a drive torque of the drive shaft is transferable to the rotary shaft in a geared manner. Therefore, for example drive units (electric motors) with a lower power may be used, to nevertheless generate a sufficient drive torque for the roller element. However, these drive units with a lower power may be formed thinner, such that this further reduces the entire thickness of the platform.

According to a further exemplary embodiment, the drive train comprises a further drive unit (for example a further electric motor), wherein the further drive unit is coupled to the gear unit, such that a further drive torque is transferable from the drive shaft to the rotary shaft in a geared manner. In particular, the drive unit and the further drive unit may be arranged in series and may therefore generate the drive torque on the drive shaft along a common axial direction. Alternatively, the drive unit and the further drive unit may be connected in parallel and may therefore, besides each other, transfer the corresponding drive torques on the drive shaft, as described in the following via a planetary gear, for example.

According to a further exemplary embodiment, the gear unit comprises a planetary gear with at least one first and a second planetary wheel, wherein the drive unit is coupled to the first planetary wheel and the further drive unit is coupled to the second planetary wheel. For example, the rotary shaft is a surrounding hollow wheel on whose inner side the planetary wheels run.

According to a further exemplary embodiment, the drive train, in particular at an axial end, comprises a rotary pin which forms a pivoting axis, wherein the rotary pin is coupled with the base body. The pivoting axis is arranged transverse to the axial direction of the drive train. In particular, the rotary pin is coupled with the base body by a sliding bearing (German: Gleitlagerung). Alternatively, additional ball bearings or roller bearings may be used.

According to a further exemplary embodiment, the drive train comprises at the axial end an electric coupling point for coupling an electric plug. In particular, the coupling point is formed in the region of the pivoting axis, such that, when pivoting the drive train, merely a relative motion of the coupling point and thus of the electric plug is generated. This reduces the holding and the wear of the plug connection. Furthermore, this may be formed by simple measures.

According to a further exemplary embodiment, the electric plug is connected with the coupling point in a watertight manner, in particular by a glue connection and/or a shrink tubing connection.

According to a further exemplary embodiment, the platform comprises a pivoting spring which is arranged between the drive train and the base body, such that a pivoting motion of the drive train relative to the base body is dampable in a defined manner. Thus, vibrations during moving the platform over the ground can be damped. Moreover, the pivoting-in velocity in case of a load can be reduced. The pivoting spring may form a leaf spring or a coil spring, for example.

According to a further exemplary embodiment, the pivoting spring comprises a degressive spring characteristic which reduces the spring force with an increase of the spring deflection (German: Einfederung) of the drive train in the receiving opening.

According to a further exemplary embodiment, the pivoting spring, in particular as a coil spring, generates a spring force along a spring force direction, wherein the pivoting spring is arranged between the base body and the drive train, such that the spring force comprises an angle between 20° and 70°, in particular between 40° and 50°. The pivoting direction is tangentially circumferentially around the pivoting axis. Substantially, the pivoting direction is arranged with a vertical component, in particular vertically. Furthermore, the pivoting direction is arranged within a damping plane which is formed by the y-z-axes and comprises a normal nD parallel to the x-axis. The weight force of the platform and the collision vehicle which is driving over it is vertical, parallel to the normal of the ground plane. The pivoting spring is arranged inclined to the normal of the ground plane, such that the spring force of the pivoting spring and correspondingly the extension direction of the pivoting spring is not arranged in parallel to the pivoting direction and does not run in parallel to the weight force, but also with the pregiven angle. During the spring deflection of the drive train in the pivoting direction, this leads to the pivoting spring being pushed together and, due to the weight force load, the pivoting spring being bent in a defined manner. This bending (German: Ausknicken) leads to the spring force being reduced and correspondingly, in case of a larger spring path, a lower spring force being adjusted due to the bending. Correspondingly, this generates the degressive spring characteristic.

According to a further exemplary embodiment, the drive train comprises a roller attachment unit, to which the roller element is exchangeably attached, wherein the roller attachment unit is rotatable around the axial direction. For example, the roller attachment unit is coupled to the drive shaft in a torque-proof manner, such that, when rotating the drive shaft, also the roller attachment unit is rotated. At the roller attachment unit, for example receiving bores for an attachment element are located, to attach the roller element by them at the roller attachment unit in a torque-proof manner.

According to a further exemplary embodiment, the roller element is releasably attachable to the roller attachment unit by a, in particular by exclusively one, attachment screw, wherein the screwing-in direction of the attachment screw is in particular in parallel to the axial direction (of the rotary shaft and the drive shaft). In particular, the drive shaft and the rotary plates may be coaxial and may comprise a common axial direction. The roller attachment unit comprises, in particular in its center or central point, a receiving bore which extends in the axial direction. The roller element comprises a through hole in the center, through which the attachment screw is inserted and is fixed in the receiving bore of the roller attachment unit.

According to a further exemplary embodiment, the roller element comprises a first contact surface, and the roller attachment unit comprises a second contact surface, wherein the first contact surface and the second contact surface comprise toothing elements which are corresponding with each other, to provide a form-locking coupling. By the form-locking coupling, the roller element is attached at the roller attachment unit in a torque-proof manner. Thus, the attachment screw pushes the roller element axially to the roller attachment unit, and the toothing elements secure a rotation of the roller element relative to the roller attachment unit.

According to a further exemplary embodiment, the corresponding toothing elements are configured such that a Hirth-toothing is providable. The Hirth-toothing forms a form-locking connection. Since teeth (protrusions) and indentations of a planar serration (German: Plan-Kerbverzahnung) fixedly engage with each other and do not roll on top of each other, the teeth are arranged statically and planar against each other. The teeth and the indentations are arranged radially, conically, and therefore are centering the roller element relative to the roller attachment unit.

According to a further exemplary embodiment, the corresponding toothing elements are configured as hemisphere-shaped elevations and respectively corresponding hemisphere-shaped indentations. During engaging the elevations and the indentations, a form-locking connection is generated, due to the hemisphere-shaped design, additionally a centering effect is generated. Thus, the roller element can be rapidly released and attached in a simple manner.

According to a further exemplary embodiment, the platform further comprises a power board which is arranged in the base body, in particular in the installation region. Furthermore, the platform comprises at least one battery cell which is coupled with the power board, such that the power board enables charging the battery cell and drawing current from the battery cell. In particular, multiple battery cells may be coupled to the power board. They may be commonly or separately charged by a logical circuit in the power board, or a same or a different power can be received from the battery cell. In particular, battery cells are single cells with a housing and an inner battery volume and assigned external connection poles. The battery cells can be individually removed from or attached to the base body. In particular, the battery cells are not accumulators, where a plurality of battery cells are integrated in a common housing and cannot be individually removed.

According to a further exemplary embodiment, the platform comprises at least two battery cells, wherein the battery cells are connected in parallel.

According to a further exemplary embodiment, the single voltages of the battery cells are highly modulable. In other words, for example, the voltages of the single battery cells may be modeled together, in a manner of speaking, they may be added, to generate a desired total power. In particular, the power board may comprise an intelligent and/or logic power control and, depending on the power requirement, may remove a desired nominal power of the single battery cells. In particular, from each battery cell, a different nominal power may be received, or from all battery cells, respectively the same nominal power may be received.

According to a further exemplary embodiment, wherein the platform comprises more than 10, in particular more than 16, battery cells.

According to a further exemplary embodiment, at least one of the battery cells is configured as a lithium titanate battery with a nominal voltage between 1.2 V and 3 V, in particular 2.4 V.

According to a further exemplary embodiment, at least one of the battery cells is configured as a flat battery with a rectangular perimeter and a thickness of less than 22 mm, in particular less than 14 mm. Thus, a plurality of flat batteries and/or battery cells may be arranged along the bottom plane, such that a flat construction height of the platform can be achieved.

According to a further exemplary embodiment, at least one of the battery cells comprises a first pole which is configured with a first contact pin, and a second pole which is configured with a second contact pin. The first contact pin and the second contact pin are coupled with corresponding receiving sockets of the power board.

According to a further exemplary embodiment, the first contact pin and the second contact pin comprise a different length. Therefore, when unplugging the battery cell from the power board, at first specifically either the plus pole or the minus pole, which is in contact with the corresponding short contact pin, can be released, and only later the plus pole and/or the minus pole of the longer contact pin. Therefore, when exchanging a battery cell, a short circuit can be avoided.

According to a further exemplary embodiment, the base body comprises at least two electrical contact surfaces which are freely accessible from outside of the platform. The contact surfaces are connected with the power board in a current conducting manner, wherein the two electrical contact surfaces are in particular configured such that sliding contacts with contact points of a stationary charging station are providable. For example, the platform may drive in a charging station and may establish an electric contact between the sliding contacts of the platform and the sliding contacts in the charging station at a certain charging position.

Furthermore, also electrical contact surfaces may be formed which are arranged below the surface or close to the bottom surface of the platform and are not freely accessible from outside. For example, the platform may drive in a charging position in an inductive charging station. Therefore, via inductive charging, the battery cells of the platform may be charged.

According to a further exemplary embodiment, the platform further comprises at least one antenna module, in particular a WLAN or a GPS antenna module, wherein the base body comprises a receiving opening at the surface, in which the antenna module is arranged.

According to a further exemplary embodiment, the antenna module is arranged in the receiving opening, such that the antenna module is in flush with the surface. Alternatively, a surface of the antenna module may be offset from the surface of the base body into the interior of the receiving opening 6 mm, in particular 3 mm or 1 mm. Therefore, even when driving over the platform with a collision vehicle, a risk of a damage of the antenna module may be reduced.

According to a further exemplary embodiment, the antenna module is configured as a flat antenna, wherein the antenna module in particular is cylindrical with a diameter of 90 mm to 50 mm, in particular comprises 70 mm. Correspondingly, the antenna module may be cylindrical and can be integrated in a correspondingly round receiving bore in the platform.

According to a further exemplary embodiment, the antenna module comprises a radiation characteristic with at least one main lobe (German: Hauptkeule) which is substantially within a horizontal plane (from the ground plane), when the platform rests on the ground. Typically, in case of antennas, the radiation direction is laid out in the vertical direction. Since in case of platforms, the sending units and the receiving units are also arranged close to the ground, the antenna module according to the disclosure is configured such that the main lobe of the radiation source is substantially horizontal. Therefore, with a low radiation power, a robust signal transmission may be provided.

According to a further exemplary embodiment, the receiving opening constitutes a through hole between the surface and the bottom surface of the base body. Therefore, a simpler demounting of the antenna module may be enabled, for example by inserting by the hand or by a tool from one side of the receiving opening and pushing-out the antenna module on the opposing side.

According to a further exemplary embodiment, the antenna module comprises a housing and an antenna electronics which is attached in the housing. Between a top side of the housing which is in flush with the surface of the base body or protrudes from the surface in the direction of the environment, and the antenna electronics, a distance volume is present. The top side of the housing is elastically deformable, such that an elastic deformation in the distance volume is providable. Therefore, the distance volume may constitute a buffer and a damping element, so that the weight force of a collision vehicle which is driving over the antenna module is damped and thus a damage at the antenna module is prevented.

According to a further exemplary embodiment, in the receiving opening between the base body and the antenna module, elastic clamping elements are provided, such that a releasable clamping attachment of the antenna module in the receiving opening is providable. The elastic clamping elements may constitute rubber-like elements, for example. For example, the elastic clamping elements are arranged in a slit between the base body and the antenna module. Depending on the elasticity and the size of the clamping element, a desired clamping force may be adjusted. The clamping force is in particular configured such that a release of the antenna module due to its own weight and due to defined shock motions in the vertical direction or in the direction of the z-axis, the antenna module is not released out of the receiving opening. At the same time, a vertical pressure or tension which is supplied by hand or by a tool is sufficient for releasing the antenna module. Therefore, a simple and rapid mounting and demounting of the antenna module can be provided.

According to a further exemplary embodiment, the antenna module comprises a reception in the peripheral surface, for attaching the clamping element. In particular, the clamping element may be cylindrical and/or may form a cylindrical column. Correspondingly, the reception may have a cylindrical shape with a circular footprint. Alternatively, the clamping element may comprise an angular, in particular a quadrangular footprint, and the reception may be correspondingly formed.

According to a further exemplary embodiment, the antenna module comprises a signal coupling point in the region of the surface of the base body, such that, from the signal coupling point, an antenna signal is transferable to a further signal coupling point of the dummy in a contact-free manner. For example, the dummy may comprise an antenna spaced apart from the platform, such that at a more suitable point, the antenna signals may be emitted.

According to a further exemplary embodiment, the roller element comprises a roller axis, wherein the roller element is rotatable around the roller axis. The base body comprises a roller reception at the bottom surface for receiving the roller axis, wherein in the roller reception, an elastic clamping element is arranged, such that a clamping attachment between the roller reception and the roller element is providable.

In particular, the clamping element may be configured cylindrical and/or may form a cylindrical column. Correspondingly, the reception may have a cylindrical shape with a circular footprint. Alternatively, the clamping element may comprise an angular, in particular quadrangular, footprint, and the reception may be correspondingly formed.

Similar like the above-described clamping element for the antenna module, the clamping element for the roller element may be arranged in a slit between the reception and the roller element.

According to a further exemplary embodiment, the elasticity and/or the size of the clamping element is configured, such that only in case of a decoupling force which is higher than the weight force of the roller element, a release of the roller element from the roller reception is enabled.

Depending on the elasticity and the size of the clamping element, the desired clamping force may be adjusted. In particular, the clamping force is configured such that a release of the roller element due to its own weight and due to defined shock motions in the vertical direction or in the direction of the z-axis, the roller element is not released from the roller reception. At the same time, a low force effort is sufficient, to release the roller element from the roller reception, such that a simple mounting and demounting, for example in a plugging process, are possible.

For example, the roller reception is configured as a receiving fork, such that the roller axis of the roller element is clamped by the clamping element in the reception. According to a further exemplary embodiment, the roller element is then configured such that the roller element rotates around the clamped roller axis.

According to a further exemplary embodiment, the roller reception is arranged at the base body rotatably around a rotation axis, wherein the roller element is attached at the roller reception eccentrically and spaced apart from the rotation axis. Therefore, when changing the driving direction of the platform, the roller element may roll in the new driving direction rapidly and without a resistance.

According to a further exemplary embodiment, the platform further comprises at least one electronic module which is arranged in the base body, wherein the electronic module comprises an electronic component, in particular with a circuit board. The electronic module comprises a planar viscoelastic damping element, in particular a cylinder-like damping element, to which the electronic component is attached. The electronic module comprises a carrier structure to which the viscoelastic damping element is attached, such that vibrations, which act from the base body on the electronic component, are dampable by the viscoelastic damping element.

The damping element comprises a cylindrical shape, for example, on whose base surface or surface the circuit board and/or the electronic component can be placed and attached. The base surface of the damping element is parallel to the bottom surface or the horizontal plane, when the platform rests on the ground. In the z-direction or in the vertical direction, the damping element may be simpler elastically deformable than in the ground plane, i.e. in the y-direction or the x-direction, since the damping element comprises a larger surface moment of inertia within the ground plane.

According to a further exemplary embodiment, the viscoelastic damping element extends within a damping plane, whose normal is parallel to the normal of a ground plane, such that the damping element is stiffer against a deformation perpendicular to the normal of the ground plane than against a deformation parallel to the normal of the ground plane, such that vertical forces which extend in parallel to the normal of the ground plane, are stronger dampable by the viscoelastic damping element than horizontal forces which extend perpendicular to the normal of the ground plane.

Correspondingly, for example sensors as electronic components may correctly measure shock motions of the platform, since merely a damping by the damping element is caused. In contrast, shock motions in a vertical direction which are disturbing in view of the measuring technique are damped by the damping element, and the electronic component is therefore attached in a gentler manner.

According to a further exemplary embodiment, the viscoelastic damping element is attached by an attachment screw at the carrier structure, wherein the attachment screw in particular comprises a screwing-in direction in parallel to the normal of the ground plane. For example, the damping element is cylindrical and comprises a through hole along its central axis, through which the attachment screw can be correspondingly introduced.

According to a further exemplary embodiment, the surface of the platform is configured at least in regions reflective, in particular for heat radiation. For example, the surface may consist of a polished metal, in particular steel or aluminum, or where appropriate, may be made of a matt and/or slightly mirror-like material. For example, the surface may be sandblasted or acid-etched, to achieve a surface which is reflective and which is matt reflective in case of higher mean roughness values.

The reflective surface may have a mean roughness value Ra [μm (micrometer)] between Ra≥0.1 μm to Ra≥12.5 μm. The reflective surface may comprise a mean roughness value Ra of Ra≥0.1 μm, in particular Ra≥ 0.2 μm, Ra≥1.6 μm, or Ra≥12.5 μm. In particular in case of a higher mean roughness value Ra (e.g. between Ra=1.6 μm and Ra=12.5 μm or more), the light is still reflected, but as a diffuse light, such that heat radiation of the sun is reflected to a large extent, and other radiation, for example radar waves, are at least partially absorbed. The surface at the reflective regions is slightly matt, such that in particular photo sensors of the vehicle to be tested perceive the matt reflective surface, for example as a surface which is similar to asphalt, such that false measurements can be prevented.

Therefore, heat radiation which is in particular generated by the sun can be reflected, such that the interior of the platform is not heated, and therefore an improved heat management is possible.

According to an exemplary embodiment, the reflective surface comprises a degree of reflection of more than 80%, in particular more than 90%, or more than 95%. Degree of reflection means that by the surface, of 100% radiation which is reaching the surface, more than 80%, in particular more than 90%, or more than 95%, are radiated back or reflected, and are not introduced or absorbed into the platform.

According to an exemplary embodiment, the platform further comprises a reflection element (e.g. a reflection plate) for a reflection of radiation, in particular heat radiation. The reflection element is at least in regions arranged along the surface of the base body spaced by an isolating distance, wherein the isolating distance is in particular filled with air or with an insulating material for a heat insulation. The shielding element itself may be an element made of a material with a low heat conductivity. The isolating distance comprises 1 mm to 5 mm, for example.

According to an exemplary embodiment, the platform further comprises a reflection element which is configured as a foil and which is glued, for example by a glue connection, on the surface of the platform. Correspondingly, the foil may be exchanged in case of a wear or a defect. The foil is configured reflective, corresponding to the above-described reflection element for reflecting radiation, in particular heat radiation (e.g. as a metal foil or a mirror foil).

In addition, in particular a platform with a combination of the reflective surface and with the radiation absorbing outer edge regions may be provided. Generally, an exemplary embodiment of the platform may be configured such that all surfaces which are arranged in parallel to the ground plane are reflective, in particular with respect to heat radiation, while all surfaces which are angled with respect to the ground plane, such as the surface of the transition region and the outer edge regions, comprise a radiation absorbing surface. The horizontal reflective surfaces do merely disturb the measurement accuracy, since the waves are reflected perpendicularly or vertically, and are therefore not guided back to the sensor unit. At the same time, heat radiation which is introduced from the vertical direction may be reflected, such that the heat management is improved without generating measurement inaccuracies. Therefore, a platform with the above-described combination of reflective and absorbing surfaces comprises a high degree of efficiency with respect to the measurement accuracy and the heat management.

Furthermore, the platform comprises at least one first functional module and a second electronic functional module which are arranged in the base body. Furthermore, the platform comprises a connection board which is arranged between the first and the second electronic functional module and the surface of the base body, wherein the first and the second electronic functional module respectively comprise at least one contact plug at a side which is facing the surface of the base body. The connection board extends along the surface between the first and the second electronic functional module and comprises corresponding contact points for receiving the contact plugs of the first and the second electronic functional modules, such that the functional modules are vertically pluggable on the connection board.

For example, a functional module and/or functional elements may describe active electronic components which receive or provide signals and electric power, such as the drive units, battery modules, or communication units. For example, the functional modules are mountable in their desired position through a receiving opening through the surface or the bottom surface of the platform. In particular, the functional modules are coupled with each other for a signal exchange and for exchanging electric power. In the present exemplary embodiment, this is performed by the connection board.

In particular, the connection board is made of a substrate, such as FR4. On the substrate, conductor traces are formed, for example printed, which form a pregiven path between two functional modules. In particular, the connection board does not comprise active switching elements, but exclusively conductor traces.

The connection board comprises contact points which are reachable through the receiving opening of the platform, in particular in a vertical plugging direction. The functional modules comprise corresponding contact plugs which are also accessible in the vertical direction. In other words, the connection board comprises two opposing main surfaces at which the contact points are formed. The conductor traces of the connection board are configured such that the contact points are connected for exchanging electric power and electric signals. Thus, in the plugged state of the functional modules at the conductor board, they are electronically connected via the conductor board. Further free wire connections between the functional modules are not necessary. Therefore, for example, the power board may be connected at one position and a communication module or the drive unit may be connected at another position in the platform at the connection board, such that, without a wire connection, due to the conductor traces in the connection board, the functional modules are connected with each other. Thus, the functional modules may be simply plugged in the vertical plugging direction at a predetermined position at the connection board, correspondingly they may be exchanged in a simple manner. Therefore, wearing the wire connections can be avoided to a large extent. For example, the connection board extends in the ground plane for example over in particular more than 50% of the installation region, in particular over the entire installation region.

In the following, further aspects are explained which enable a thin configuration of the platform, depending or not depending on the previously described platform. All aspects which are described in the following may be combined with the above-described exemplary embodiments.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The platform further comprises a drive train which comprises a drive unit, wherein the roller element is coupled with the drive unit for transferring a drive torque. The drive train and the roller element are coupled behind each other along an axial direction, such that the drive train, together with the roller element, is at least partially present in a receiving opening in the bottom surface of the base body, wherein the drive train with the roller element is arranged pivotably into and out of the receiving opening.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The platform further comprises a power board which is arranged in the base body, in particular in the installation region, and at least one battery cell which is coupled with the power board, such that the power board enables charging and drawing current from the battery cell.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The platform further comprises at least one antenna module, in particular a WLAN or a GPS antenna module, wherein the base body comprises a receiving opening at the surface, in which the antenna module is arranged.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The roller element comprises a roller axis, wherein the roller element is rotatable around the roller axis. The base body comprises at the bottom surface a roller reception for receiving the roller axis, wherein an elastic clamping element is arranged in the roller reception, such that a clamping attachment between the roller reception and the roller element is providable.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The platform further comprises at least one electronic module which is arranged in the base body, wherein the electronic module comprises an electronic component, in particular with a circuit board. The electronic module comprises a planar viscoelastic damping element, in particular a cylindrical damping element, at which the electronic component is attached. The electronic module comprises a carrier structure at which the viscoelastic damping element is attached, such that vibrations which act from the base body on the electronic component, are dampable by the viscoelastic damping element.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The surface of the platform is at least in regions reflective, in particular for heat radiation.

According to a further aspect, a platform for a dummy for simulating traffic situations is described. The platform comprises a base body which comprises a bottom surface and a surface which is formed opposing to the bottom surface, and at least one roller element which is arranged at the bottom surface, wherein the roller element is configured such that the base body is displaceable along a ground by the roller element. The platform further comprises at least one first functional module and a second electronic functional module which are arranged in the base body. Furthermore, the platform comprises a connection board which is arranged between the first and the second electronic functional module and the surface of the base body, wherein the first and the second electronic functional module comprise a contact plug respectively at a side of the base body which is facing the surface. The connection board extends along the surface between the first and the second electronic functional module and comprises corresponding contact points for receiving the contact plug of the first and the second electronic functional module, such that the functional modules are vertically pluggable on the connection board.

It is noted, that the here described embodiments merely constitute a limited selection of possible embodiments of the disclosure. Hence, it is possible to combine the features of individual embodiments with each other in a suitable manner, such that, for the skilled person, a plurality of different embodiments is to be considered as obviously disclosed by the here explicit embodiments. In particular, some embodiments of the disclosure are described with device claims and other embodiments of the disclosure are described with method claims. However, it is immediately clear for the skilled person that, unless explicitly otherwise indicated, additionally to a combination of features which belong to one type of inventive subject-matter, also an arbitrary combination of features is possible, which belong to different types of inventive subject-matters.

### BRIEF DESCRIPTION OF THE DRAWING

In the following, for a further explanation and for a better understanding of the present disclosure, embodiments are described in more detail with reference to the accompanying drawings.

FIG. 1 shows a schematic illustration of a side view of a displaceable platform according to an exemplary embodiment.

FIG. 2 shows a schematic illustration of a plan view of the platform of FIG. 1.

FIG. 3 shows a schematic illustration of a pivotable drive train according to an exemplary embodiment.

FIG. 4 shows a schematic illustration of a pivotable drive train with pivoting springs according to an exemplary embodiment.

FIG. 5 shows a schematic illustration of a coupling of a roller element at the drive train according to an exemplary embodiment.

FIG. 6 shows a schematic illustration of an attachment of a roller element at a roller attachment unit by clamping elements according to an exemplary embodiment.

FIG. 7 shows a schematic illustration of a power board with battery cells according to an exemplary embodiment.

FIG. 8 shows a schematic illustration of an attachment of antenna modules in the platform according to an exemplary embodiment.

FIG. 9 shows a schematic illustration of a radiation characteristic of an antenna module according to an exemplary embodiment.

FIG. 10 shows a schematic illustration of an antenna module according to an exemplary embodiment of the present disclosure.

FIG. 11 shows a schematic illustration of a connection board which is installed in the base body, according to an exemplary embodiment of the present disclosure.

FIG. 12 shows a schematic illustration of an electronic module with a damping mechanics according to an exemplary embodiment of the present disclosure.

FIG. 13 shows a schematic illustration of an attachment of the roller element at the base body of the circuit board according to an exemplary embodiment of the present disclosure.

### DETAILED DESCRIPTION OF EXEMPLARY EMBODIMENTS

Identical or similar components in the figures are provided with the same reference numerals. The illustrations in the figures are schematic.

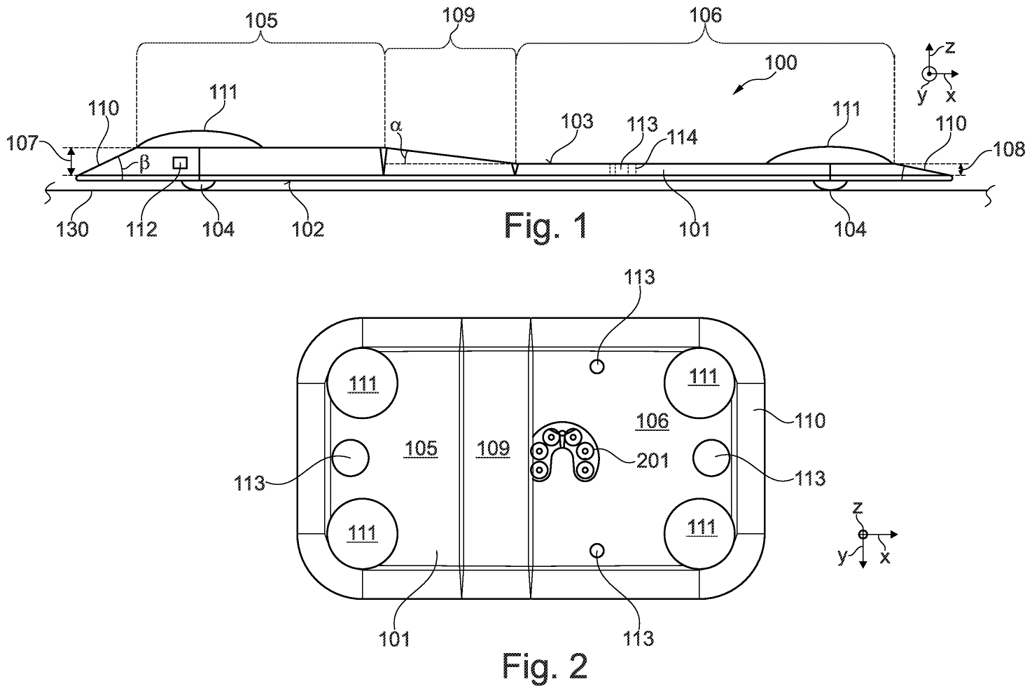

FIG. 1 shows a schematic illustration of a side view of a displaceable platform 100 according to an exemplary embodiment. FIG. 2 shows a schematic illustration of a plan view of the platform 100 of FIG. 1. The platform 100 comprises a base body 101 which comprises a bottom surface 102 and a surface 103 which is formed opposing to the bottom surface 102, and at least one roller element 104 which is arranged at the bottom surface 102, 103, wherein the roller element 104 is configured such that the base body 101 is displaceable along a ground 130 by the roller element 104, wherein the base body 101 comprises an attachment region 106 and an installation region 105. On the attachment surface of the attachment region 106, an attachment device 201 for attaching the dummy is formed, wherein functional elements are installable in the installation region 105. The base body 101 is configured so thin, that a collision vehicle can drive over the base body 101 without a damage.

The base body 101 comprises a bottom surface 102 and an opposing surface 103. The base body 101 is placed with its bottom surface 102 on a ground 130. In this case, the bottom surface 102 is parallel to the ground 130 and/or to the ground plane. In the bottom surface 102, the at least one roller element 104 is rotatably arranged, which at least partially protrudes out of the base body 101 and therefore provides a distance between the base body 101 and the ground 130. On the surface 103, an attachment device 201 is formed. The attachment device 201 is configured for fixing the dummy. Furthermore, the attachment device 201 may be configured controllable, to selectively, for example short before a collision situation, release the test object, such that the attachment between the base body 101 and the test object is released. The ground plane is defined by an x-axis (for example in the driving direction of the platform 100) and a Y-axis. Thus, the x-axis and the Y-axis lie in the ground plane. Perpendicular to the ground plane and thus in parallel to the normal of the ground plane, the z-axis is (vertically) arranged.

In particular, the platform 100 comprises an installation region 105, in which all functional elements and/or functional modules, such as the drive units or the communication units, of the platform 100 are arranged. In the attachment region 106, the dummy is attached on the attachment surface. Along the ground plane, the platform 100 is divided in the attachment region 106 and the installation region 105.

The base body 101 is configured step-shaped, such that an installation thickness 107 between the bottom surface 102 and the surface 103 in the installation region 105 is larger than an attachment thickness 108 between the bottom surface 102 and the surface 103 in the attachment region 106.

Hence, the platform 100 comprises two different thickness regions. In the thicker installation region 105, the functional elements are accommodated which typically require a larger thickness. In the attachment region 106 on which the dummy is attached, for example exclusively driveless roller elements 104 are located, such that no further thicker functional elements need to be installed. The attachment region 106 may therefore be formed thinner than the installation region 105.

Between the installation region 105 and the attachment region 106, a transition region 109 is formed, wherein the surface 103 in the transition region 109 comprises an angle α to the surface 103 in the installation region 105 (and/or the attachment region 106) between 5° and 45°, in particular between 5° and 15°. In particular, the angle α is measured between the plane (or its normal) in which the transition region 109 is arranged and the ground plane (or its normal). In particular when forming the transition region 109 with an inclined, oblique course, a direct reflection of sensor beams, such as radar waves, may be avoided.

The base body 101 comprises outer edge regions 110 which surround the attachment region 106 and/or the installation region 105, wherein the outer edge regions 110 are configured wedge-shaped, and wherein at least one wedge-shaped outer edge region 110 comprises an opening angle β of approximately below 25°. The wedge-shaped outer edge regions 110 thus form a ramp over which the collision vehicle can reach the cover surface and/or the surface 103 of the platform 100 in a gentle manner and can drive over the entire platform 100. In particular, the opening angle β is measured between the ground plane (and/or its normal) and the plane (and/or its normal) in which the surface 103 of the wedge-shaped outer edge regions 110 is arranged. In addition, by the wedge-shaped outer edge regions 110, a reflection of sensor radiation is reflected back with a vertical component, such that the risk of false measurements is reduced. The outer edge regions 110 comprise a radiation absorbing, in particular radar waves absorbing, surface 103, in particular with the color RAL 7005 or RAL 7035.

The surface 103 comprises a dome-shaped covering element in the region of the roller element 104. Therefore, despite a narrow installation region 105, roller elements 104 with a larger roller radius may be used. The installation space which is required for this may be generated by the dome-shaped covering elements. Due to the dome shape, additionally, the sensor radiation is not reflected directly back, but with a vertical component, such that false measurements can be reduced.

The surface 103 of the platform 100 is at least partially in regions reflective, in particular for heat radiation. For example, the surface 103 may consist of a polished metal or, if applicable, may be made of a mirror-like material. Therefore, heat radiation which is in particular generated by the sun may be reflected, such that the interior of the platform 100 is not heated and thus an improved heat management is possible. The platform 100 may be configured such that all surfaces which are arranged in parallel to the ground plane are in particular reflective with respect to heat radiation, while all surfaces which are angled with respect to the ground plane, such as the surface 103 of the transition region 109 and the outer edge regions 110 comprise a radiation absorbing surface 103.

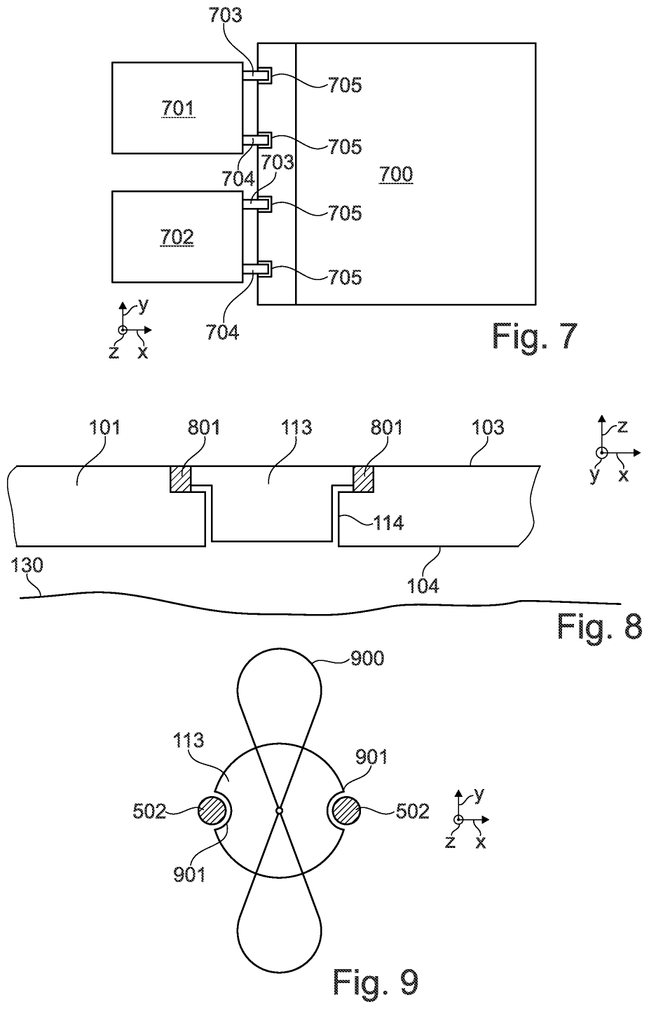

According to a further exemplary embodiment, the base body 101 comprises at least two electrical contact surfaces 112 which are freely accessible from outside of the platform 100. The contact surfaces 112 are connected with a power board 700 (see FIG. 7) in a current conducting manner, wherein the two electrical contact surfaces 112 are in particular configured such that sliding contacts with contact points of a stationary charging station are providable. For example, the platform 100 may drive in a charging station and may establish an electrical contact between the sliding contacts of the platform 100 and the sliding contacts in the charging station in a certain charging position.

The platform 100 further comprises at least one antenna module 113, in particular a WLAN or a GPS antenna module 113, wherein the base body 101 comprises a receiving opening 114 at the surface 103, in which the antenna module 113 is arranged.

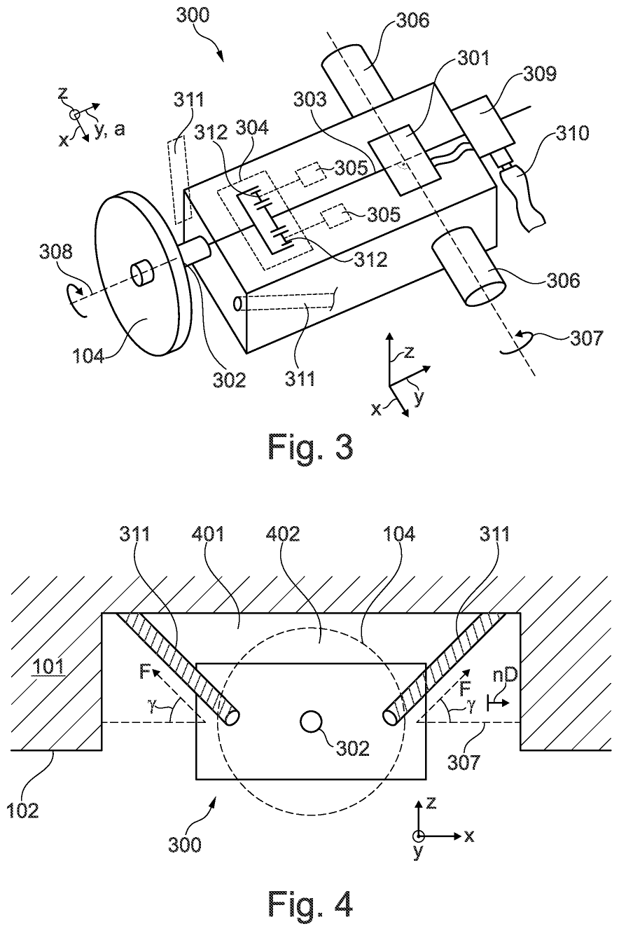

FIG. 3 shows a schematic illustration of a pivotable drive train 300 according to an exemplary embodiment. The platform 100 further comprises a drive train 300 which comprises a drive unit 301, wherein the roller element 104 is coupled with the drive unit 301 for transferring a drive torque. The drive train 300 and the roller element 104 are coupled behind each other along an axial direction, such that the drive train 300 together with the roller element 104 is at least partially present in a receiving opening 401 in the bottom surface 102 of the base body 101, wherein the drive train 300 with the roller element 104 is arranged pivotably into and out of the receiving opening 401 (see FIG. 4).

For example, the drive train 300 may comprise a housing and/or a carrying structure in which all functional mechanical components, such as the drive unit 301 or bearings for the shafts are arranged. According to the disclosure, the drive train 300 is pivotably arranged at the base body 101, such that in case of a load (in particular a weight force by a collision vehicle which is driving over it) in a vertical direction, the drive train 300 together with the roller element 104 is pivoted in the direction of the platform 100, to damp the load stress and, if applicable, to securely accommodate the roller element 104 together with the drive train 300 in a receiving region, for example in an installation box, such that no further weight force of the collision vehicle is transferred to the drive train 300 and the roller element 104. This is in particular possible, when in a pivoted-in state of the drive train and the roller element 104 in a receiving region of the platform 100 and/or of the base body 101, the entire weight force of the platform 100 and the collision vehicle which is driving over it is introduced via the base body 101 into the ground 130 and no longer via the roller element 104. Therefore, a thin platform 100 which is highly robust with respect to heavy collision vehicles (for example heavy load trucks) can be provided.

The drive unit 301 comprises a drive shaft 303 and the roller element 104 comprises a rotary shaft 302, wherein the drive unit 301 and the roller element 104 are arranged such that the drive shaft 303 and the rotary shaft 302 are arranged in parallel to the axial direction a. The drive unit 301 and the roller element 104 are arranged such that the drive shaft 303 and the rotary shaft 302 are coaxial.

The drive train comprises a gear unit 304, in particular a planetary gear, which is arranged between the drive shaft 303 and the rotary shaft 302, such that a drive torque of the drive shaft 303 is transferable to the rotary shaft 302 in a geared manner. Therefore, for example drive units 301, 305 (electric motors) with a low power may be used, to nevertheless generate a sufficient drive torque for the roller element 104.

The drive train comprises a further drive unit 305 (for example a further electric motor), wherein the further drive unit 305 is coupled to the gear unit 304, such that a further drive torque is transferable from the drive shaft 303 to the rotary shaft 302 in a geared manner. In particular, the drive unit 301 and the further drive unit 305 may be arranged in series and may therefore generate the drive torque on the drive shaft 303 along a common axial direction a. Alternatively, the drive unit 301 and the further drive unit 305 may be connected in parallel and may therefore, besides each other, transfer the corresponding drive torques to the drive shaft 303, for example via a planetary gear, as described in the following.

The gear unit 304 comprises a planetary gear with at least one first and a second planetary wheel 312, wherein the drive unit 301 is coupled to the first planetary wheel 312 and the further drive unit 305 is coupled to the second planetary wheel 312 (see dashed illustration and FIG. 3). For example, the rotary shaft 302 is a circulating hollow wheel on whose inner side the planetary wheels 312 run.

The drive train 300 comprises, in particular at an axial end, a rotary pin 306 which forms a pivoting axis 307, wherein the rotary pin 306 is coupled with the base body 101. The pivoting axis 307 is arranged transverse to the axial direction a of the drive train 300. In particular, the rotary pin 306 is coupled by a sliding bearing with the base body 101. Alternatively, additional ball bearings or roller bearings may be used.

The drive train comprises at the axial end an electric coupling point 309 for coupling an electric plug 310. In particular, the coupling point 309 is formed in the region of the pivoting axis 307, such that, when pivoting the drive train 300, merely a relative motion of the coupling point 309 and thus of the electric plug is generated.

A pivoting spring 311 is arranged between the drive train 300 and the base body 101, such that a pivoting motion of the drive train 300 relative to the base body 101 is dampable in a defined manner.

FIG. 4 shows a schematic illustration of a pivotable drive train 300 with pivoting springs 311 according to an exemplary embodiment.

The pivoting springs 311 comprise a degressive spring characteristic which reduces the spring force with an increase of the spring deflection (German: Einfederung) of the drive train 300 in the receiving opening 401. The pivoting spring 311, in particular as a coil spring, comprises a spring force F along a spring force direction, wherein the pivoting spring 311 is arranged between the base body 101 and the drive train 300, such that the spring force comprises an angle γ between 20° and 70°, in particular between 40° and 50°.

The pivoting direction is arranged tangentially circumferentially around the pivoting axis 307. The pivoting direction is substantially arranged with a vertical component, in particular vertically. Furthermore, the pivoting direction is arranged within a damping plane which is formed by the y-z-axes and comprises a normal nS parallel to the x-axis. The weight force of the platform 100 and the collision vehicle which is driving over it is arranged vertically, parallel to the normal of the ground plane. The pivoting spring 311 is arranged inclined to the normal of the ground plane, such that the spring force of the pivoting spring 311 and correspondingly the extension direction of the pivoting spring 311 is not arranged in parallel to the pivoting direction or the normal nS and not in parallel to the weight force, but also with the pregiven angle γ. This leads to pushing together the pivoting spring 311 when deflecting the drive train 300 in the pivoting direction, and to bending the pivoting spring 311 in a defined manner due to the weight force load. This bending leads to reducing the spring force and correspondingly adjusting a lower spring force due to the bending in case of a larger spring path. Correspondingly, this generates the degressive spring characteristic.

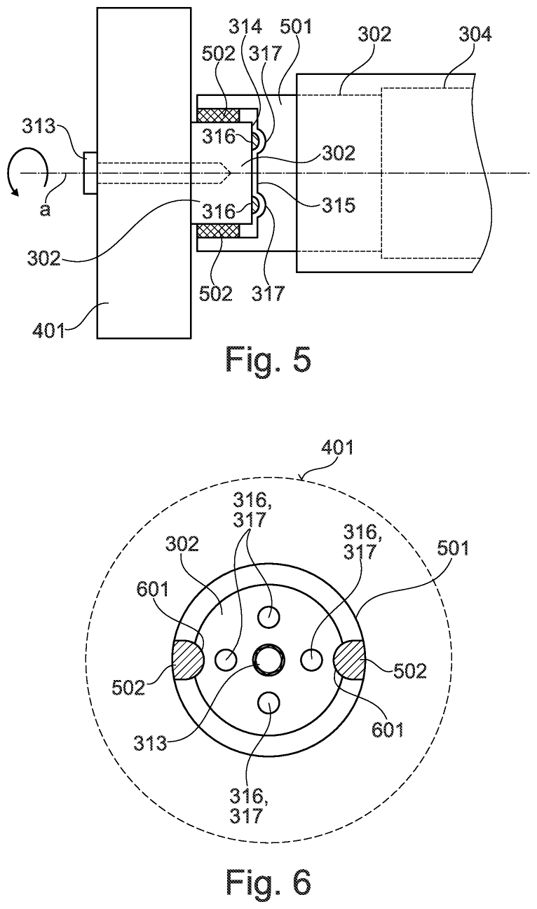

FIG. 5 shows a schematic illustration of a coupling of the roller element 104 to the drive train 300 according to an exemplary embodiment.

The drive train 300 comprises a roller attachment unit 501 at which the roller element 104 is attachable in an exchangeable manner, wherein the roller attachment unit 501 is rotatable around the axial direction a. For example, the roller attachment unit 501 is attached to the drive shaft 303 in a torque-proof manner, such that, when rotating the drive shaft 303, also the roller attachment unit 501 is rotated. At the roller attachment unit 501, for example receiving bores for an attachment element are arranged, to torque-proofly attach the roller element 104 to the roller attachment unit 501 by it.

The roller element 104 is releasably attachable at the roller attachment unit 501 by a, in particular by exclusively one, attachment screw 313, wherein the screwing-in direction of the attachment screw 313 is in particular in parallel to the axial direction a (of the rotary shaft 302 and of the drive shaft 303). In particular, the drive shaft 303 and the rotary plate may be coaxial and comprise a common axial direction a. The roller attachment unit 501 comprises, in particular in its center or central point, a receiving bore which is extending in the axial direction a. The roller element 104 comprises a through hole in the center, through which the attachment screw 313 is inserted and is fixed in the receiving bore of the roller attachment unit 501.

The roller element 104 comprises a first contact surface 314 and the roller attachment unit 501 comprises a second contact surface 315, wherein the first contact surface 314 and the second contact surface 315 comprise toothing elements which are corresponding with each other, to provide a form-locking coupling. By the form-locking coupling, the roller element 104 is attached at the roller attachment unit 501 in a torque-proof manner. Therefore, the attachment screw pushes the roller element 104 axially to the roller attachment unit 501 and the toothing elements secure a rotation of the roller element 104 relatively to the roller attachment unit 501. The corresponding toothing elements are configured as hemisphere-shaped elevations 316 and respectively corresponding hemisphere-shaped indentations 317. When engaging the elevations 316 and the indentations 317, a form-locking connection is generated due to the hemisphere-shaped design, and additionally, a centering effect is generated. Therefore, the roller element 104 may be quickly released and attached, in a simple manner.

In the roller attachment unit 501, for attaching the rotary shaft 302, an elastic clamping element 502 is arranged, such that a clamping attachment between the roller attachment unit 501 and the roller element 104 is established.

FIG. 6 shows a schematic illustration of an attachment of a roller element 104 at a roller attachment unit 501 by clamping elements according to an exemplary embodiment. In particular, a plan view of the front surface of the rotary shaft 302 which is facing the drive train 300 is shown. On the rotary shaft 302, four or more hemisphere-shaped elevations 316 or indentations 317 are circumferentially arranged. At the outer surfaces of the rotary shaft 302, receptions 601, e.g. receiving grooves, are formed. In particular, the clamping element 502 may be cylindrical and/or may form a cylindrical column. Correspondingly, the reception 601 may have a cylindrical shape with a circular footprint. Alternatively, the clamping element 502 may comprise an angled, in particular quadrangular, footprint and the reception 601 may be formed correspondingly. The rotary shaft 302 is pushed in the roller attachment unit 501, such that the elastic clamping elements 502 deform and generate a clamping force which attaches the rotary shaft 302 in the roller attachment unit 501.

FIG. 7 shows a schematic illustration of a power board 700 with battery cells 701, 702 according to an exemplary embodiment. The platform 100 further comprises a power board 700 which is arranged in the base body 101, in particular in the installation region 105. Furthermore, the platform 100 comprises battery cells 701, 702 which are coupled with the power board 700, such that the power board 700 enables charging the and drawing current from the battery cells 701, 702. The battery cells 701, 702 are connected in parallel. The battery cells 701, 702 are configured as a flat battery with a quadrangular perimeter and a small thickness.

The battery cells 701, 702 comprise a first pole which is configured with a first contact pin 703, and a second pole which is configured with a second contact pin 704. The first contact pin 703 and the second contact pin 704 are coupled with corresponding receiving sockets 705 of the power board 700. The first contact pin 703 and the second contact pin 704 comprise different lengths.

FIG. 8 shows a schematic illustration of an attachment of antenna modules in the platform 100 according to an exemplary embodiment. The antenna module 113 is arranged in the receiving opening 114, such that the antenna module 113 is in flush with the surface 103. Therefore, even when driving over the platform 100 with a collision vehicle, a risk of a damage of the antenna module 113 can be reduced.

The antenna module 113 is configured as a flat antenna, wherein the antenna module 113 is in particular cylindrical and may be integrated in a corresponding round receiving bore 114 in the platform 100. The receiving opening 114 constitutes a through hole between the surface 103 and the bottom surface 102 of the base body 101. Therefore, a simpler demounting of the antenna module 113 may be enabled, for example by inserting by hand or by a tool from a side of the receiving opening 114 and by pushing out the antenna module 113 on the opposing side.

In the receiving opening 114, between the base body 101 and the antenna module 113, elastic clamping elements 502 are provided, such that a releasable clamping attachment of the antenna module 113 in the receiving opening 114 is providable. The elastic clamping elements 502 may constitute rubber-like elements, for example. The elastic clamping elements 502 are arranged in a slit between the base body 101 and the antenna module 113, for example. Depending on the elasticity and the size of the clamping element 502, the desired clamping force may be adjusted. The clamping force is in particular configured, such that a release of the antenna module 113 due to its own weight and due to defined impact motions in the vertical direction or in the direction of the z-axis, the antenna module 113 is not released out of the receiving opening 114.

FIG. 9 shows a schematic illustration of a radiation characteristic 900 of an antenna module 113 according to an exemplary embodiment. The antenna module 113 comprises a reception 901 (receiving groove) in the circumferential surface for attaching the clamping element 502. In particular, the clamping element 502 may be cylindrical or may form a cylindrical column. Correspondingly, the reception 901 may have a cylindrical shape with a circular footprint. Alternatively, the clamping element 502 may comprise an angled, in particular quadrangular, footprint, and the reception 901 may be correspondingly formed.

The antenna module 113 comprises a radiation characteristic 900 with at least one main lobe and is arranged such that the main lobe is substantially within a horizontal plane (since the ground plane), when the platform 100 rests on the ground 130. Typically, in case of antennas, the radiation direction is implemented in the vertical direction.

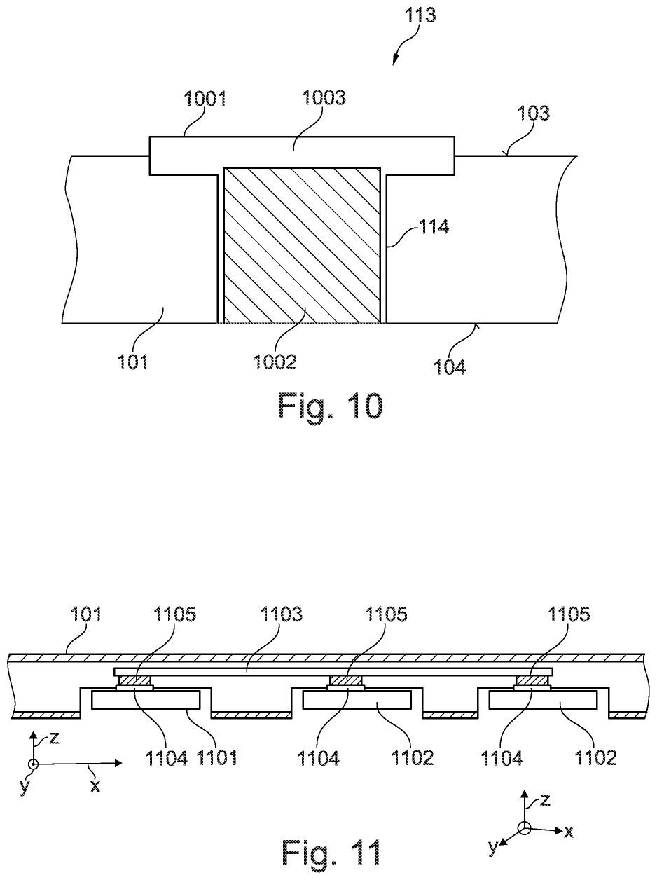

FIG. 10 shows a schematic illustration of the antenna module 113 according to an exemplary embodiment of the present disclosure. The antenna module 113 comprises a housing 1001 and an antenna electronics 1002 which is attached in the housing 1001. Between a top side of the housing 1001 which is in flush with the surface 103 of the base body 101 or which protrudes from the surface 103 in the direction of the environment, and the antenna electronics 1002, a distance volume 1003 is present. The top side of the housing 1001 is configured elastically deformable, such that an elastic deformation in the distance volume 1003 is providable. Therefore, the distance volume 1003 may constitute a buffer and a damping element, such that the weight force of a collision vehicle which is driving over the antenna module 113 is damped and therefore a damage at the antenna module 113 is prevented.

FIG. 11 shows a schematic illustration of a connection board 1103 which is installed in the base body 101, according to an exemplary embodiment.

The platform 100 further comprises at least one first functional module 1101 and a second electronic functional module 1102 which are arranged in the base body 101. Furthermore, the platform 100 comprises a connection board 1103 which is arranged between the first and the second electronic functional module 1101, 1102 and the surface 103 of the base body 101, wherein the first and the second electronic functional module 1101, 1102 respectively comprise at least one contact plug 1104 at a side which is facing the surface 103 of the base body 101. The connection board 1103 extends along the surface 103 between the first and the second electronic functional module 1101, 1102 and comprises corresponding contact points 1105 for receiving the contact plugs 1104 of the first and the second electronic functional modules 1101, 1102, such that the functional modules 1101, 1102 are vertically pluggable on the connection board 1103.

A functional module 1101, 1102 and/or functional elements may describe active electronic components, for example, which draw or provide signals and electric power, such as the drive units 301, battery modules, or communication units. For example, the functional modules 1101, 1102 are mountable in their desired position through a receiving opening 114 through the surface 103 or the bottom surface 102 of the platform 100. In particular, the functional modules 1101, 1102 are coupled with each other for a signal exchange and for exchanging electric power. In the present exemplary embodiment, this is performed by the connection board 1103.

The connection board 1103 comprises contact points 1105 which are accessible through the receiving opening of the platform 100, in particular in the vertical plugging direction. The functional modules 1101, 1102 comprise corresponding contact plugs 1104 which are also accessible in the vertical direction. In other words, the connection board 1103 comprises two opposing main surfaces at which the contact points 1105 are formed. The conductor traces of the connection board 1103 are configured such that the contact points 1105 are connected for exchanging electric power and electric signals. In the plugged state of the functional modules 1101, 1102 to the connection board 1103, they are therefore electronically connected via the connection board 1103. Further free connection wires between the functional modules 1101, 1102 are not required. Therefore, for example, the power board 700 may be connected at one position, and a communication module or the drive unit 301 are connected to another position in the platform 100 to the connection board 1103, such that, due to the conductor traces in the connection board 1103, the functional modules 1101, 1102 are connected with each other without a wire connection. Therefore, the functional modules 1101, 1102 can be simply plugged in the vertical plugging direction at a predetermined position to the connection board 1103 and can be correspondingly exchanged in a simple manner.

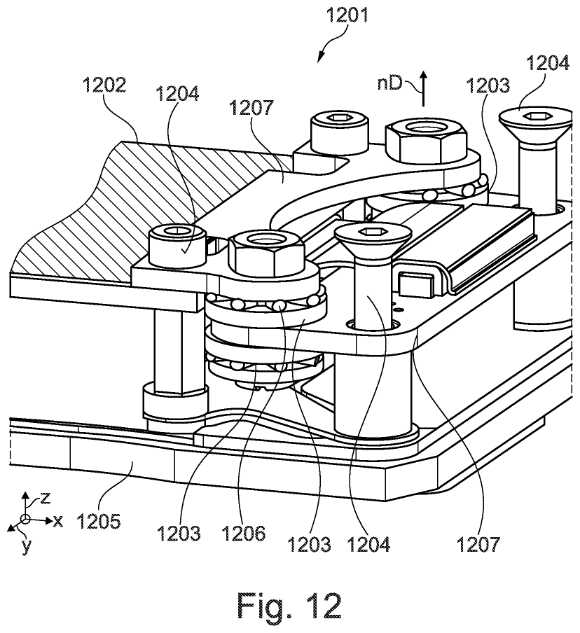

FIG. 12 shows a schematic illustration of an electronic module 1201 with a damping mechanics according to an exemplary embodiment.

The platform 100 further comprises at least one electronic module 1201 which is arranged in the base body 101, wherein the electronic module 1201 comprises an electronic component 1202, in particular with a circuit board. The electronic module 1201 comprises a planar viscoelastic damping element 1203, in particular a cylindrical damping element 1203, to which the electronic component 1202 is attached. The electronic module 1201 comprises a carrier structure 1205, to which the viscoelastic damping element 1203 is attached by an attachment element 1204, for example an attachment screw, such that vibrations which act from the base body 101 on the electronic component 1202 are dampable by the viscoelastic damping element.

For example, the damping element 1203 comprises a cylindrical shape on whose basic surface or surface the circuit board or the electronic component 1202 can be placed and attached. The basic surface of the damping element 1203 is in parallel to the bottom surface 102 or the horizontal plane, when the platform 100 rests on the ground 130. In the z-direction or in the vertical direction, the damping element 1203 may be easier elastically deformable than in the ground plane, i.e., in the y-direction or the x-direction, since the damping element 1203 comprises a larger surface moment of inertia within the ground plane.

The viscoelastic damping element 1203 extends within a damping plane whose normal nd is in parallel to the normal of a ground plane, such that the damping element 1203 is stiffer against a deformation perpendicular to the normal of the ground plane than against a deformation in parallel to the normal of the ground plane, such that vertical forces which extend in parallel to the normal of the ground plane are stronger dampable by the viscoelastic damping element 1203 than horizontal forces which extend perpendicular to the normal of the ground plane.

Correspondingly, for example sensors as electronic components may correctly measure the impact motions of the platform 100, since merely a damping by the damping element 1203 is caused. In contrast, impact motions in the vertical direction which are disturbing with respect to the measuring technique, are damped by the damping element 1203, and the electronic component 1202 is therefore attached in a gentler manner.

To increase the motion towards the sides and/or the stiffening in the ground plane, planar connection plates 1207 are provided which are arranged horizontally, i.e. in the x-y-plane, between the attachment elements 1204, for example attachment screws. The damping element 1203 may comprise elevations 1206 vertically in the Z-direction, which partially surround the connection plates 1207. Therefore, the elevations 1206 form a seat for the connection plates 1207.

The viscoelastic damping element 1203 is attached to the carrier structure 1205 by the attachment element 1204 or the attachment screw, wherein the attachment screw 1204 comprises a screwing-in direction in parallel to the normal of the ground plane or its normal nD of the damping plane. For example, the damping element 1203 is cylindrical and comprises a through hole along its central axis, through which the attachment element 1204 can be correspondingly inserted.

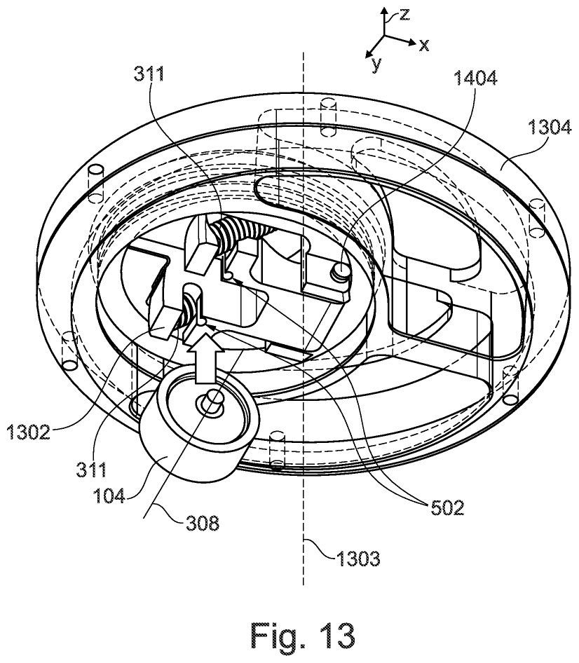

FIG. 13 shows a schematic illustration of an attachment of a roller element 104 to the base body 101 of the circuit board according to an exemplary embodiment.

The roller element 104 comprises a roller axis 1301, wherein the roller element 104 is rotatable around the roller axis 1301. The base body 101 comprises at the bottom surface 102 a roller reception 1302 for receiving the roller axis 1301, wherein in the roller reception 1302, an elastic clamping element 502 is arranged, such that a clamping attachment between the roller reception 1302 and the roller element 104 is providable. The elasticity and/or the size of the clamping elements 502 is configured such that only in case of a decoupling force which is higher than the weight force of the roller element 104, a release of the roller element 104 from the roller reception 1302 is enabled.

For example, the roller reception 1302 is configured as a receiving fork, such that the roller axis 1301 of the roller element 104 is clamped in the reception 1302 by the clamping element 502. Then, the roller element 104 is configured such that the roller element 104 rotates around the clamped roller axis 1301. Furthermore, the roller reception 1302 may be pivotably attached to the carrier structure 1304 around a pivoting axis 1304 which is arranged perpendicular to the rotation axis 1303 and within a x-y-plane, such that the roller reception 1302 together with the roller element 104 can pivot in and out relatively to the platform 100. The pivoting spring 311 is arranged between the roller reception 1302 and the carrier structure 1304, such that a pivoting motion of the roller reception 1302 relative to the carrier structure 1304 is dampable in a defined manner. For example, the pivoting springs 311 comprise a degressive spring characteristic which reduces the spring force when increasing the spring deflection of the roller reception 1302 to the carrier structure 1304.

The roller reception 1302 is arranged at the base body 101 or at a corresponding carrier structure 1304 rotatably around a rotation axis 1303, wherein the roller element 104 is attached eccentrically and spaced apart from the rotation axis 1303 at the roller reception 1302. Therefore, when changing the displacement direction of the platform 100, the roller element 104 can roll along the new displacement direction rapidly and without a resistance.

Supplementally, it should be noted that “comprising” does not exclude other elements or steps, and “a” or “an” does not exclude a plurality. Further, it should be noted that features or steps that have been described with reference to one of the above embodiments may also be used in combination with other features or steps of other embodiments described above. Reference signs in the claims are not to be regarded as a limitation.

List of reference signs:

| | |
|---|---|
| 100 | platform |
| 101 | base body |
| 102 | bottom surface |
| 103 | surface |
| 104 | roller element |
| 105 | installation region |
| 106 | attachment region |
| 107 | installation thickness |
| 108 | attachment thickness |
| 109 | transition region |
| 110 | outer edge region |
| 111 | dome region |
| 112 | electrical contact surface |
| 113 | antenna module |
| 114 | receiving opening |
| 130 | ground |
| 201 | attachment device |
| 300 | drive train |
| 301 | drive unit |
| 302 | rotary shaft |
| 303 | drive shaft |
| 304 | gear unit |
| 305 | further drive unit |
| 306 | rotary pin |
| 307 | pivoting axis |
| 308 | rotation axis |
| 309 | coupling point |
| 310 | electrical plug |
| 311 | pivoting spring |
| 312 | planetary wheel |
| 313 | attachment screw |
| 314 | first contact surface |
| 315 | second contact surface |
| 316 | hemisphere-shaped elevations |
| 317 | hemisphere-shaped indentations |
| 401 | receiving opening |
| 501 | roller attachment unit |
| 502 | elastic clamping element |
| 601 | reception for clamping element |
| 700 | power board |
| 701 | first battery cell |
| 702 | second battery cell |
| 703 | first contact pin |
| 704 | second contact pin |
| 705 | receiving socket |
| 900 | radiation characteristic |
| 901 | reception for clamping element |
| 1001 | housing |
| 1002 | antenna electronics |
| 1003 | distance volume |
| 1101 | first functional module |
| 1102 | second functional module |
| 1103 | connection board |
| 1104 | contact plug |
| 1105 | contact point |
| 1201 | electronic module |
| 1202 | electronic component |
| 1203 | damping element |
| 1204 | attachment element |
| 1205 | carrier structure |
| 1206 | elevation |
| 1207 | connection plates |
| 1301 | roller axis |
| 1302 | roller reception |
| 1303 | rotation axis roller reception |
| 1304 | pivoting axis roller reception |
| α | angle transition region |
| β | angle outer edge region |
| γ | angle pivoting spring |
| a | axial direction |
| nD | normal damping plane |
| nS | normal pivoting plane |

1. A platform for a dummy for simulating traffic situations, the platform comprising:
a base body which comprises a bottom surface and a surface which is formed opposing to the bottom surface,
at least one roller element which is arranged at the bottom surface,
wherein the roller element is configured such that the base body is displaceable along a ground by the roller element,
wherein the base body comprises an attachment region and an installation region,
wherein on the attachment surface of the attachment region, an attachment device for attaching the dummy is formed,
wherein in the installation region, functional elements are installable, wherein the base body is configured so thin, that a collision vehicle can drive over the base body without a damage.

2. The platform according to claim 1, comprising at least one of the following features:
wherein the base body is configured in a step-shaped manner;
wherein the attachment thickness is less than 40 mm, or
wherein the installation thickness is less than 60 mm or less than 55 mm or
wherein the maximum thickness of the platform between a ground support of the roller element on the ground and the surface is less than 60 mm or less than 55 mm;
wherein the attachment region comprises more than 30% of the surface of the base body;
wherein between the installation region and the attachment region, a transition region is formed,
wherein the surface in the transition region comprises an angle, α, to the surface in the installation region or the attachment region between 5° and 45°.

3.-5. (canceled)

6. The platform according to claim 1,
wherein the base body comprises outer edge regions which surround the attachment region and/or the installation region,
wherein the outer edge regions are configured wedge-shaped,
wherein at least one wedge-shaped outer edge region comprises an opening angle of less than 30°.

7. The platform according to claim 6, comprising at least one of the following features:
wherein the outer edge regions comprise a radiation absorbing, in-particular surface;
wherein the surface of the outer edge regions comprises a grey coating;
wherein the surface in the region of the roller element comprises a dome-shaped covering element.

8.-9. (canceled)

10. The platform according to claim 1, further comprising:
a drive train which comprises a drive unit,
wherein the roller element is coupled with the drive unit for transferring a drive torque,
wherein the drive train and the roller element are coupled behind each other along an axial direction, such that the drive train together with the roller element is at least partially located in a receiving opening in the bottom surface of the base body,
wherein the drive train with the roller element is arranged pivotably into and out of the receiving opening.

11. The platform according to claim 5,
wherein the drive unit comprises a drive shaft, and the roller element comprises a rotary shaft,
wherein the drive unit and the roller element are arranged such that the drive shaft and the rotary shaft are in parallel to the axial direction;
wherein the drive unit and the roller element are arranged such that the drive shaft and the rotary shaft are coaxial;
wherein the drive train comprises a gear unit between the drive shaft and the rotary shaft, such that a drive torque of the drive shaft is transferable to the rotary shaft in a geared manner.

12.-13. (canceled)

14. The platform according to claim 6, comprising at least one of the following features:
wherein the drive train comprises a further drive unit,
wherein the further drive unit is coupled to the gear unit, such that a further drive torque is transferable from the drive shaft to the rotary shaft in a geared manner;
wherein the gear unit comprises a planetary gear with at least one first and a second planetary wheel, wherein the drive unit is coupled to the first planetary wheel, and the further drive unit is coupled to the second planetary wheel.

15. (canceled)

16. The platform according to claim 5, comprising at least one of the following features:
wherein the drive train comprises a rotary pin which forms a pivoting axis,
wherein the rotary pin is coupled with the base body,
wherein the pivoting axis is transverse to the axial direction of the drive train;
wherein the drive train comprises an electric coupling point at the axial end for coupling an electric plug;
wherein the electric plug is connected with the coupling point in a watertight manner.

17.-18. (canceled)

19. The platform according to claim 5, further comprising at least one of the following features:
a pivoting spring which is arranged between the drive train and the base body, such that a pivoting motion of the drive train relative to the base body is dampable in a defined manner;
wherein the pivoting spring comprises a degressive spring characteristic which reduces the spring force with an increase of the spring deflection of the drive train in the receiving opening;
wherein the pivoting spring generates a spring force along a spring force direction,
wherein the pivoting spring is arranged between the base body and the drive train such that the spring force comprises an angle, γ, between 20° and 70°.

20.-21. (canceled)

22. The platform according to claim 5,
wherein the drive train comprises a roller attachment unit at which the roller element is exchangeably attached,
wherein the roller attachment unit is rotatable around the axial direction;
wherein the roller element is releasably attachable to the roller attachment unit by an attachment screw.

23. (canceled)

24. The platform according to claim 10,
wherein the roller element comprises a first contact surface, and the roller attachment unit comprises a second contact surface,
wherein the first contact surface and the second contact surface comprise toothing elements which are corresponding with each other, to provide a form-locking coupling.

25. The platform according to claim 11, comprising one of the following features:
wherein the corresponding toothing elements are configured such that a Hirth-toothing is providable; or
wherein the corresponding toothing elements are configured as hemisphere-shaped elevations and respectively corresponding hemisphere-shaped indentations.

26. (canceled)

27. The platform according to claim 1, further comprising:
a power board which is arranged in the base body and
at least one battery cell which is coupled with the power board, such that the power board enables charging and drawing current from the battery cell.

28. The platform according to claim 27, further comprising at least one of the following features:
at least two battery cells,
wherein the battery cells are connected in parallel;
wherein the individual voltages of the battery cells are highly modulable;
wherein the platform comprises more than 10 battery cells;
wherein at least one of the battery cells is configured as a lithium titanate battery with a nominal voltage between 1.2 V and 3 V;
wherein at least one of the battery cells is configured as a flat battery with a rectangular perimeter with a thickness of less than 22 mm;
wherein at least one of the battery cells comprises a first pole which is formed with a first contact pin, and a second pole which is formed with a second contact pin,
wherein the first contact pin and the second contact pin are coupled with corresponding receiving sockets of the power board;
wherein the first contact pin and the second contact pin comprise a different length.

29.-34. (canceled)

35. The platform according to claim 27,
wherein the base body comprises at least two electrical contact surfaces which are freely accessible from outside of the platform,
wherein the contact surfaces are connected with the power board in a current conducting manner.

36. The platform according to claim 1, further comprising at least one of the following features:
at least one antenna module,
wherein the base body at the surface comprises a receiving opening in which the antenna module is arranged;
wherein the antenna module is arranged in the receiving opening, such that the antenna module is in flush with the surface, or
wherein a surface of the antenna module is offset from the surface of the base body into the interior of the receiving opening 6 mm;
wherein the antenna module is configured as a flat antenna;
wherein the antenna module comprises a radiation characteristic with at least one main lobe which is substantially within a horizontal plane, when the platform rests on the ground;
wherein the receiving opening constitutes a through hole between the surface and the bottom surface of the base body;
wherein the antenna module comprises a housing and an antenna electronic which is attached in the housing,
wherein between a top side of the housing which is in flush with the surface of the base body, or which protrudes from the surface in the direction of the environment, and the antenna electronic, a distance volume is present,
wherein the top side of the housing is elastically deformable, such that an elastic deformation in the distance volume is providable;
wherein in the receiving opening between the base body and the antenna module, elastic clamping elements are provided, such that a releasable clamping attachment of the antenna module in the receiving opening is providable;
wherein the antenna module comprises a reception in the peripheral surface for attaching the clamping element;
wherein the antenna module in the region of the surface of the base body comprises a signal coupling point, such that an antenna signal is transferable from the signal coupling point to a further signal coupling point of the dummy in a contactless manner.

37.-44. (canceled)

45. The platform according to claim 1, comprising at least one of the following features:
wherein the roller element comprises a roller axis,
wherein the roller element is rotatable around the roller axis,
wherein the base body comprises a roller reception at the bottom surface for receiving the roller axis,
wherein an elastic clamping element is arranged in the roller reception, such that a clamping attachment between the roller reception and the roller element is providable;
wherein the elasticity of the clamping elements is configured such that only in case of a decoupling force which is higher than the weight force of the roller element, a release of the roller element from the roller reception is enabled;
wherein the roller reception at the base body is arranged rotatably around a rotation axis,
wherein the roller element is attached at the roller reception eccentrically and spaced apart from the rotation axis.

46.-47. (canceled)

48. The platform according to claim 1, further comprising:
at least one electronic module which is arranged in the base body,
wherein the electronic module comprises an electronic component, in particular with a circuit board,
wherein the electronic module comprises a planar viscoelastic damping element at which the electronic component is attached,
wherein the electronic module comprises a carrier structure at which the viscoelastic damping element is attached, such that vibrations which act from the base body on the electronic component are dampable by the viscoelastic damping element.

49. The platform according to claim 48, comprising at least one of the following features:
wherein the viscoelastic damping element extends within a damping plane whose normal is in parallel to the normal of a ground plane, such that the damping element with respect to a deformation perpendicular to the normal of the bottom plane, is stiffer than with respect to a deformation in parallel to the normal of the ground plane, such that vertical forces which extend in parallel to the normal of the ground plane are stronger dampable by the viscoelastic damping element than horizontal forces which extend perpendicular to the normal of the ground plane;
wherein the viscoelastic damping element is attached at the carrier structure by an attachment screw.

50. (canceled)

51. The platform according to claim 1, comprising at least one of the following features:
wherein the surface at least in regions is configured reflective,
wherein the reflective surface comprises a degree of reflection of more than 80%;
further comprising:
a reflection element for reflecting radiation,
wherein the reflection element is arranged along the surface of the base body with an isolating distance;
further comprising:
at least one first functional module and a second electronic functional module which are arranged in the base body,
a connection board which is arranged between the first and the second electronic functional module and the surface of the base body,
wherein the first and the second electronic functional module comprise at least one contact plug respectively at a side which is facing the surface of the base body,
wherein the connection board extends along the surface between the first and the second electronic functional module and comprises corresponding contact points for receiving the contact plugs of the first and the second electronic functional modules, such that the functional modules are vertically pluggable on the connection board.

52.-54. (canceled)
